(19) United States
(12) Patent Application Publication
(10) Pub. No.: US 2006/0252668 A1
(43) Pub. Date: Nov. 9, 2006

(54) Dilute fabric care compositions comprising thickners and fabric care compositions for use in the presence of anionic carry-over

(76) Inventors: Gayle Marie Frankenbach, Cincinnati, OH (US); Alessandro Corona III, Mason, OH (US); Alice Marie Ward, Middletown, OH (US); Sanaul Siddiquee, Brussels (BE); Yonas Gizaw, Cincinnati, OH (US); Lisa Grace Brush, Cincinnati, OH (US); Geoffrey Marc Wise, Reading, OH (US); Darren Franklin King, West Chester, OH (US); Aniesa Parakkat, Fort Wright, KY (US); Jocelyn Michelle McCullough, Cincinnati, OH (US); Walter Augusta Maria Broeckx, Berlare (BE); Mark Robert Sivik, Mason, OH (US); Jose Andres Rojo Moreno, Loveland, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/405,729

(22) Filed: Apr. 18, 2006

Related U.S. Application Data
(60) Provisional application No. 60/672,325, filed on Apr. 18, 2005.
(60) Provisional application No. 60/673,153, filed on Apr. 20, 2005.
(60) Provisional application No. 60/673,230, filed on Apr. 20, 2005.

(51) Int. Cl. C11D 3/00

(52) U.S. Cl. 510/504; 510/515

(57) ABSTRACT

The present invention relates to fabric care compositions that comprise thickeners and the use of fabric care composition in high anionic surfactant conditions.

### CROSS REFERENCE

This application claims priority to U.S. Provisional Application Ser. No. 60/672,325 filed Apr. 18, 2005, U.S. Provisional Application Ser. No. 60/673,153 filed Apr. 20, 2005, and U.S. Provisional Application Ser. No. 60/673,230 filed Apr. 20, 2005, the disclosure of which is incorporated by referenced herein.

### FIELD OF INVENTION

The present invention relates to fabric care compositions comprising a thickener. The present invention also relates to fabric care compositions for use in the presence of high anionic carry-over conditions.

### BACKGROUND OF THE INVENTION

Fabric care compositions deliver a number of desirable characteristics to fabrics upon treatment, including an improved fabric feel and a perception of freshness. However, in order to secure high consumer acceptance of any fabric care composition, it is essential to provide consumer-desirable product aesthetics, for example not only an appealing neat product odor and a pleasant product color, but especially an appropriate product rheology and satisfactory physical product stability. Controlling the rheology of the fabric care composition becomes increasingly challenging as the concentration of the fabric softening active is lowered (i.e., dilute). There is a continuing need to provide thickeners for fabric care composition comprising a low (e.g., less than 10%) fabric softener active level to achieve commercially acceptable product rheology. As used herein, the term “thickener” means a compound that increases the viscosity of the composition. Although thickeners have been generally disclosed, there is a continuing need to find a combination of fabric softener active(s) and thickeners to provide enhanced deposition.

There is also a continuing need to identify thickeners that are water dispersible. A thickener that is easily water dispersible may reduce the cycle time and costs associated with manufacturing processes. An easily water dispersible polymer allows for the quick incorporation of the thickener in many phases of the manufacturing process.

There is also a continuing need to provide fabric care compositions wherein the fabric softener active forms small sized (e.g., less than 3 microns in diameter) particles. Fabric softening actives formed as small sized particles may provide more uniform softening on fabrics and/or deeper penetration in depositing onto fabric.

See e.g., U.S. Pat. Nos. 6,271,192; and 6,465,416 both by Daniel Verstrat, et al.; and U.S. Pat. Pub. No. 2004/0229769 A1.

The presence of anionic surfactant carry-over (particularly under hand washing conditions) there are additional challenges that must be met by the fabric care composition, including the formation of suds and scum residue during the rinse. See e.g., U.S. Pat. Pub. No. 2003/0060390 A1. It is important to control suds formation in both machine and hand-rinse conditions. In the case of machine-rinse conditions, uncontrolled sudsing can lead to temporary machine failure, known as suds lock. In the case of hand-rinse conditions, sudsing is an undesirable user experience because sudsing is a signal to the user that the laundry has not been effectively rinsed. The user will continue to rinse fabrics until suds are abated thereby wasting both water and time in the laundry process. Therefore, there is a need for a fabric care composition that eliminates suds, especially in a first rinse bath solution.

There is also a continuing need to provide a fabric softening product that can be used in a first rinse bath solution without forming flocs. Floc (e.g., scum residue), can be formed by the presence of some cationic fabric softener actives in the presence of anionic surfactant, negatively affecting the softness performance.

There is also a need to provide an inexpensive fabric care product, particularly in hand-rinse and economically developing geographies, that will address one or more the abovementioned needs in a cost effective manner.

The present invention attempts to address these and other needs.

### SUMMARY OF THE INVENTION

One aspect of the invention provides a dilute fabric care composition comprising a

(a) fabric softener active, preferably from about 1% to about 12% by weight of the composition; wherein the fabric softener active comprises an ester quaternary ammonium compound suitable for softening fabric, wherein the ester quaternary ammonium compound forms particles in said composition, wherein the particles are distributed so at least about 50% of the total number of the ester quaternary ammonium particles comprise an average diameter of less than about 3 microns, but preferably greater than 0.05 microns, as measured by the HORIBA Light Scattering Technique;

(b) a thickener comprising a polymerization product of:

(i) about 5 to about 80 weight percent of the thickener of an alkyl ester of acrylic acid or an alkyl ester of methacrylic acid, wherein the alkyl group is linear or branched containing 1 to 22 carbons and optionally interrupted by oxygen;

(ii) about 5 to about 80 weight percent of the thickener of a monomer chosen from: a vinyl-substituted heterocyclic compound containing at least one nitrogen, oxygen, or sulfur atom; (meth)acrylamide; a mono- or di-alkylamino alkyl(meth)acrylate; or a mono or di-alkylamino alkyl(meth)acrylamide, wherein the alkyl group preferably has 1 to 4 carbon atoms;

(iii) about 0.01 to about 30 weight percent of the thickener of an associative monomer chosen from at least one of the following:
(1) a urethane reaction product of a monoethylenically unsaturated isocyanate and a non-ionic surfactant comprising C₁-C₄ alkoxy-terminated, a block copolymer of ethyelene oxide, propylene oxide, or 1,2-butyleneoxide oxide;
(2) an ethylenically unsaturated copolymerizable surfactant monomer obtained by condensing a nonionic surfactant with an ethylenically unsaturated carboxylic acid or the anhydride thereof;
(3) a surfactant monomer chosen from a urea reaction product of a monoethylenically unsaturated monoisocyanate with a nonionic surfactant having amine functionality;
(4) an allyl ether of the formula CH₂═CR′CH₂OAₘBₙAₚR wherein R′ is hydrogen or methyl, A is propyleneoxy or butyleneoxy, B is ethyleneoxy, n is zero or an integer, m and p are zero or an integer less than n, and R is a hydrophobic group of at least 8 carbon atoms; and
(5) a nonionic urethane monomer which is an urethane reaction product of a monohydric nonionic surfactant with a monoethylenically unsaturated isocyanate;

(iv) about 0 to about 1 weight percent of the thickener of a cross-linking monomer having at least two ethylenically unsaturated moieties;

(c) water;

(d) a viscosity of from about 10 cPs to about 1000 cPs.

In yet another aspect of the invention, it is found that compositions comprising a specific mixture of mono-tail and di-tail cationic fabric softener active together with select silicone suds suppressors provides both the benefit of instantaneous suds kill and/or floc inhibition. Such compositions save user effort and conserve cost and environmental impact of water usage.

One aspect of the invention provides a fabric care composition comprising

(a) a fabric softener active:

(i) wherein the fabric softener active comprises from about 1% to about 12% by weight of the composition;

(ii) wherein the fabric softener active comprises an ester quaternary ammonium compound suitable for softening fabric;

(iii) wherein the ester quaternary ammonium compound comprises a monoester species and a diester species;
(1) wherein the monoester species comprises from about 10% to about 50% by weight of the ester quaternary ammonium compound;
(2) wherein the diester species comprises from about 15% to about 80% by weight of the ester quaternary ammonium compound;
(3) wherein the mole ratio of the monoester species to diester species comprises from about 0.5:1 to about 1.3:1, respectively;

(vi) wherein the ester quaternary ammonium compound forms particles in the composition; wherein the particles are distributed so less than about 20% of the total number of ester quaternary ammonium compound particles have an average diameter greater than about 3 microns, as measured by the HORIBA Light Scattering Technique;

(b) from about 0.001% to about 10% by weight of the composition of a silicone comprising suds suppressor.

Another aspect of the invention provides for the use of a composition of the present invention for use in softening fabric comprising the step of administering the composition to a rinse bath solution, preferably a first rinse bath solution.

Another aspect of the invention provides for use of a fabric softening active or thickener for the manufacture of a fabric care composition for the treatment of fabric, wherein the treatment comprises the steps: (a) adding the fabric conditioning composition to a first rinse bath solution; (b) rinsing manually the fabric in the first rinse bath solution.

Another aspect of the invention provides for use of a fabric care composition of the present invention for the treatment fabric, wherein the treatment comprises the steps: (a) adding the fabric conditioning composition to a first rinse bath solution; (b) rinsing manually the fabric in the first rinse bath solution.

Another aspect of the invention provides for a kit comprising the abovementioned composition and optionally instructions for use.

### DETAILED DESCRIPTION OF THE INVENTION

In one aspect, the present invention relates to a dilute fabric care composition comprising: (a) a fabric softener active that forms particles in the composition, wherein the particles are disturbed so at least about 50% by total number of the fabric softener active particles comprise an average diameter of less than 3 microns, but greater than 0.05 microns; (b) a thickener; (c) water; and (d) a viscosity of from about 10 cPs to about 1000 cPs.

In another aspect, the present invention relates to a fabric care composition comprising: (a) a fabric softener active, wherein the fabric softener comprises an ester quaternary ammonium compound comprises a monoester species and a diester species; (b) a silicone comprising suds suppressor.

### A. FABRIC SOFTENER ACTIVE

Any compound can be used, for purposes of the present invention, as a fabric softener active provided the compound imparts a softening benefit to treated fabric. In one embodiment of the invention, the fabric softener active (hereinafter “FSA”) is a quaternary ammonium compound suitable for fabric softening. In one embodiment, the FSA is an ester quaternary ammonium compound. In another embodiment, the FSA is formed from a reaction product of a fatty acid and an amine obtaining mixtures of mono-, di-, and even tri-species compounds.

Diester Quaternary Ammonium (DEOA) Compounds

In one embodiment, the FSA comprises a DEQA compound. In certain aspects of the present invention the DEQA compounds encompass a description of diamido FSAs and FSAs with mixed amido and ester linkages as well as the aforementioned diester linkages.

A first type of DEQA (“DEQA (1)”) suitable as a FSA in the present compositions includes compounds of the formula:
{R₄₋ₘ—N⁺—[(CH₂)ₙ—Y—R¹]ₘ}X⁻
wherein each R substituent is either hydrogen, a short chain C₁-C₆, preferably C₁-C₃ alkyl or hydroxyalkyl group, e.g., methyl (most preferred), ethyl, propyl, hydroxyethyl, and the like, poly (C₂₋₃ alkoxy), preferably polyethoxy, group, benzyl, or mixtures thereof; each m is 2 or 3; each n is from 1 to about 4, preferably 2; each Y is —O—(O)C—, —C(O)—O—, —NR—C(O)—, or —C(O)—NR— and it is acceptable for each Y to be the same or different; the sum of carbons in each R¹, plus one when Y is —O—(O)C— or —NR—C(O)—, is C₁₂-C₂₂, preferably C₁₄-C₂₀, with each R¹ being a hydrocarbyl, or substituted hydrocarbyl group; it is acceptable for R¹ to be unsaturated or saturated and branched or linear and preferably it is linear; it is acceptable for each R¹ to be the same or different and preferably these are the same; and X⁻ can be any softener-compatible anion, preferably, chloride, bromide, methylsulfate, ethylsulfate, sulfate, phosphate, and nitrate, more preferably chloride or methyl sulfate. Preferred DEQA compounds are typically made by reacting alkanolamines such as MDEA (methyldiethanolamine) and TEA (triethanolamine) with fatty acids. Some materials that typically result from such reactions include N,N-di(acyl-oxyethyl)-N,N-dimethylammonium chloride or N,N-di(acyl-oxyethyl)-N,N-methylhydroxyethylammonium methylsulfate wherein the acyl group is derived from animal fats, unsaturated, and polyunsaturated, fatty acids, e.g., oleic acid, and/or partially hydrogenated fatty acids, derived from vegetable oils and/or partially hydrogenated vegetable oils, such as, canola oil, safflower oil, peanut oil, sunflower oil, corn oil, soybean oil, tall oil, rice bran oil, etc. Non-limiting examples of suitable fatty acids are listed in U.S. Pat. No. 5,759,990 at column 4, lines 45-66.

In one embodiment, the fabric softener active is one described in U.S. Pat. Pub. No. 2004/0204337 A1, published Oct. 14, 2004 to Corona et al., from paragraphs 30-79.

In another embodiment, the fabric softener active is one described in U.S. Pat. Pub. No. 2004/0229769 A1, published Nov. 18, 2005, to Smith et al., on paragraphs 26-31; or U.S. Pat. No. 6,494,920, at column 1, line 51 et seq. detailing an “esterquat” or a quaternized fatty acid triethanolamine ester salt.

Those skilled in the art will recognize that active softener materials made from such process can comprise a combination of mono-, di-, and tri-esters depending on the process and the starting materials. Materials from this group for the present invention may include, in one embodiment, those comprising a high level of diester content; typically greater than 40%, preferably greater than 55%, still more preferably greater than 60%, of the total softener active weight (as used herein, the “total softener active weight” includes the mass encompassing all reaction products that comprise one or more R¹ and this weight is used to quantify the individual percentages of mono-, di-, and tri-ester reaction products by dividing the individual masses of mono-, di-, and tri-ester by the hereinabove stated total softener active and multiplying this number by 100 to give a percentage of the total).

In one aspect of the present invention, wherein the composition is used in applications with low anionic carry-over in the rinse bath, it is desired to have the following mole ratios of diester species to monoester species; at least about 2 moles of diester to about 1 mole of monoester, preferably at least about 3 moles of diester to about 1 mole of monoester, and most preferably at least about 5 moles of diester to about 1 mole of monoester. It is acceptable for this aspect of the invention to have no monoester present, but typically there is less than about 40 moles of diester to about 1 mole of monoester, and preferably less than 20 moles of diester to about 1 mole of monoester and more preferably less than about 10 moles of diester to about 1 mole of monoester and most preferably less than about 6 moles of diester to about 1 mole of monoester. In this aspect of the invention, wherein the composition is used in conditions of low anionic carry-over, it is typical to have at least about 30% and preferably at least about 40% by of total softener active weight contributed by a diester species.

In a second aspect of the present invention, wherein the composition is used in application having high anionic carry-over in the rinse bath, it is desired to have the following mole ratios of diester to monoester species; typically less than about 2 moles of diester to about 1 mole of monoester, preferably less than 1.6 moles of diester to about 1 mole of monoester, more preferably about 1.3 mole of diester to about 1 mole of monoester, and typically more than 0.5 mole of diester for 1 mole of monoester, preferably more than about 1 mole of diester for 1 mole of monoester. In this aspect of the invention, it is typical to have at least about 60% diester, more preferably at least about 65% diester, even more preferably at least about 70% diester of the total softener active weight.

The FSA, in one embodiment, is preferably chosen from at least one of the following: ditallowoyloxyethyl dimethyl ammonium chloride, dihydrogenated-tallowoyloxyethyl dimethyl ammonium chloride, ditallow dimethyl ammonium chloride, ditallowoyloxyethyl dimethyl ammonium methyl sulfate, dihydrogenated-tallowoyloxyethyl dimethyl ammonium chloride, dihydrogenated-tallowoyloxyethyl dimethyl ammonium chloride, and mixtures thereof.

In one embodiment the FSA comprises from at least about 1%, alternatively at least about 2%, alternatively at least about 3%, alternatively at least about 4%, alternatively at least about 5%, alternatively about 6%, alternatively at least about 7%; but not greater than about 14%, alternatively not greater than about 12%, alternatively not greater than 10%, alternatively not greater 9%, alternatively not greater than about 8%, alternatively not greater than about 7%, alternatively not greater than about 6%, alternatively not greater than about 5% by weight of the fabric care composition.

1. Monoester Level in FSA

One aspect of the invention provides a monoester species level in the FSA of at least about 10% but not greater than about 50% by the total softener active weight. As used herein, the “total FSA weight” includes the mass encompassing all reaction products that comprise one or more R¹ and this weight is used to quantify the individual percentages of mono-, di-, and tri-ester reaction products by dividing the individual masses of mono-, di-, and tri-esters by the hereinabove stated total softener active weight and multiplying this number by 100 to give a percentage of the total.

Without wishing to be bound by theory, the monoester may provide up to at least three benefits to the fabric care compositions of the present invention.

Firstly, increasing the monoester species content (at least relative to the diester and/or triester content) of the FSA increases the solubility of the FSA in water (as well as a broad range of solvents). However, too high a level of monoester species content provides a FSA that does not provide enough softening efficiency. It is the diester species content of the FSA that may most significantly provide the fabric softening benefits.

Secondly, a monoester species level in the FSA in the ranges described herein provides compositions that exhibit excellent resilience to anionic surfactant carry-over conditions. For example, if the composition of the present invention is used as a “single rinse” fabric softener product (e.g., DOWNY Single Rinse), the user will typically bring a considerable amount of anionic surfactant carryover into the rinse bath solution. This may be particularly true in a hand washing conditions. The term “anionic surfactant carrier-over” means the anionic surfactant that may be present either on the fabric or in the wash liquor during the wash cycle of the laundry process and that is carried over with the laundered fabrics into the rinse bath solution. In turn, the term “rinse bath solution” means the solution used to rinse the fabric subsequent to their washing. Users may typically use multiple rinse bath solutions in so-called rinse process. A “first rinse bath solution” means the first solution used to rinse the fabric subsequent to their washing.

Many fabric softening products will instruct the user to at least rinse the laundry in a rinse bath solution at least once, after washing the laundry, to remove the detersive detergent, from the laundry, before rinsing with the softening product. In other words, these products will typically instruct the user to use the product in the last rinse cycle. Many of these products, if used in the first rinse step, will typically result in floc formation in the rinse bath solution from the positively charged cationic fabric softener active reacting with the negatively charged anionic surfactant in anionic surfactant carrier-over. This floc often yields to a particulate or filmy white scum adhering to fabric. The floc formation may result whether the laundry process is conducted manually, automatically, semi-automatically, or combinations thereof. The term “flocs” means the visible precipitates, or flocculated matter which is generally opaque in nature, or scum or residue on the surface rinse bath solution. Although not necessarily solid or compact, such flocs are sufficiently large to be noticeable by the unaided eye, typically, not less than about 0.4 mm when measured along its shortest axis. Flocs are undesirable because it can deposit on fabric leaving an undesirable appearance often times resulting in the user to re-wash the laundry thereby leading to wasted time, effort, and water.

There are at least two ways to measure resilience of the fabric care composition of the present invention to anionic surfactant carry-over conditions.

(a) Floc Formation Test Method. One embodiment of the invention provides for the absence or substantially the absence of floc formation in a first rinse bath solution under anionic surfactant carry-over conditions. A suitable Floc Formation Test Method is detailed in U.S. Pat. Appl. Pub. No. US 2003/0060390, to Demeyere, published Mar. 27, 2003, at paragraphs 227-228. Notably the test solution is defined as being “substantially free” from flocs if the total number of visible flocs retained on the sieve is less than 50. The test solution is being defined as being “free” from flocs if the number of visible flocs retained is less than 10. One embodiment of the invention provides for the use of a fabric care composition of the present invention to soften fabric in a first rinse bath solution such that the rinse bath solution is substantially free from flocs, preferably free from flocs, in the first rinse bath solution.

(b) Anionic Carryover Tolerance Test: One embodiment of the invention provides for a fabric care composition that exhibits superior anionic carryover tolerance (while preferably still providing commercially acceptable fabric softness). The Anionic Carryover Tolerance Test is herein defined: The first sign of floc formation to the unaided eye is considered an end point. A 0.6% sodium dodecyl benzyne sulfonate (NaLAS) solution is used as the titrant solution. 0.75 g of FSA is placed in about a 225 ml vessel and then filled to about 75 g with 14 grains per gallon water (3:1 Ca:Mg hardness). A mixer (such as a Ika Werke model RW 20 DZM with an impellor having a 4 cm diameter blade with about a 20° slant) on a slow setting (about 350 rpm) is used to disperse the FSA in the vessel. The contents of the vessel are titrated with the titrant solution at rate of about 1 drop per second until floc formation is observed. Data is averaged over three replicates. The greater the time elapses before floc formation is observed, the greater the anionic carry-over tolerance of a given fabric care composition.

A third and final reason the monoester levels described herein may provide particularly useful benefits is by providing compositions that may achieve a microstructure in the composition that is substantially unilamellar in appearance when examined by electron microscopy. One embodiment of the invention provides for a FSA that forms particles in the fabric care composition. Without wishing to be bound by theory, compositions with smaller particle sizes may provide a more uniform softening on fabrics and deeper penetration into the fabric for deposition as compared to those fabric care compositions with larger particle sizes. Additionally, and again without wishing to be bound by theory, when the FSA comprises an ester quaternary ammonium compound, an optimal ratio of monoester species to diester species may contribute, at least in part, to a smaller vesicle size formation. Moreover, an optimized ratio of monoester to diester may also lead to compositions (in addition to having a smaller particle size) that are more resilient to anionic carryover conditions thereby providing improved fabric softness under these conditions.

There are at least two methods of determining particle size for purposes of the present invention.

(a) One method is by the HORIBA™ Light Scattering Technique. The term “HORIBA™ Light Scattering Technique” means a technique where particle-size distribution (as an average particle diameter size) is determined using a HORIBA™ LA-910 Laser Scattering Particle Size Distribution Analyzer equipped with a flow cell. Approximately 0.3 mL of fabric softener composition is added to approximately 150 mLs of deionized water in the sampling chamber (so that the transmission intensity is between 80-95%, as specified by HORIBA). The sample is circulated and analyzed within 1 minute of introduction into the sample chamber. Thereafter, the particle size distribution is measured using Horiba LA-910 Measurement Program, Version 1.30, using the volume distribution base and a relative refractive index of 1.03. For purposes of clarification, one skilled in the art will readily appreciate that FSA formed particles may comprise other ingredients in relatively minor amounts such as, but not limited to, unreacted fatty acids from the manufacture of ester quaternary ammonium compounds or hydrophobic perfume ingredients that have migrated into the particle. In one embodiment, the particles are distributed so less than about 20% of the total number of ester quaternary ammonium compound particles have a diameter greater than about 3 microns, as measured by the HORIBA Light Scattering Technique. In a second embodiment, the particles are distributed so less than about 10% of the total number of ester quaternary ammonium compound particles have a diameter greater than about 1 micron, as measured by the HORIBA Light Scattering Technique.

(b) A second method of measuring particle size includes by way the Harmonic Intensity Averaged Particle Diameter. The “Harmonic Intensity Averaged Diameter” is described in the article entitled “Particle Sizing by Photon Correlation Spectroscopy. Part 2. Average values,” by Finsy, R. and Dejaeger, N. in the journal entitled Particle & Particle Systems Characterization, volume 8, issue 3, from pages 187-193 (September 1991). Briefly, Photon Correlation Spectroscopy (PCS) 4700 equipment (Malvern, U.K.) is used with a vertically polarized 10 mW He—Ne laser with a wavelength of 633 nm. The scattering angle is 90° C. Samples are in 75×10 mm cylindrical cuvettes. Data is processed by a multi 8-bit 7032CN digital correlator with 4×16 channels and a dilation factor of 4. The autocorrelation function is accumulated during 60 seconds. The fundamental sampling time is automatically selected by the software. The temperature is at 25° C. and the detector aperture is at 150 μm. DLS data analysis is conducted using the CONTIN option in the Malvern Instruments PCS v1.36 software. Product sample is diluted 500-1000 times with de-ionized water to obtain a suitable light scattering intensity. Three measurements are done per sample.

In one embodiment, the Harmonic Intensity Averaged Diameter of the FSA (e.g., ester quaternary ammonium compound) particles is at less than about 250 nm, preferably less than about 200 nm, preferably less than about 180 nm. In another embodiment, the Harmonic Intensity Averaged Diameter of the FSA is greater than about 10 nm, alternatively greater than about 50 nm, alternatively greater than about 100 nm; but all less than about 250 nm.

In another embodiment, the particles are distributed so less than about 20% of the total number of ester quaternary ammonium compound particles have an average diameter greater than about 3 microns, as measured by the HORIBA Light Scattering Technique.

2. Diester Level in FSA

One aspect of the invention provides for a level of diester species content in the FSA from about 15% to about 80% by the total softener active weight. This range of diester surprising balances enough of softening benefit yet allows for enough monoester content. Examples of diester compounds of the present invention may include one or more of the following: N,N-di(tallowoyloxyethyl)-N,N-dimethylammonium chloride (available from Akzo under the trade name Armosoft® DEQ) and N,N-di(canola-oyloxyethyl)-N,N-dimethylammonium chloride (available from Degussa under the trade name Adogen® CDMC). Nonlimiting examples of available TEA ester quats suitable for the present invention include di-(hydrogenated tallowoyloxyethyl)-N,N-methylhydroxyethylammonium methylsulfate and di-(oleoyloxyethyl)-N,N-methylhydroxyethylammonium methylsulfate sold under the trade names Rewoquat® WE 15 and Varisoft® WE 16, both available from Degussa.

3. Triester Level in FSA.

One aspect of the invention provides for a level of triester species content in the FSA from about 0% to about 40% by the total softener active weight. Another aspect of the invention provides the FSA to be free or essentially free of triester.

The FSA in the present compositions is preferably selected from the group consisting of ditallowoyloxyethyl dimethyl ammonium chloride, dihydrogenated-tallowoyloxyethyl dimethyl ammonium chloride, ditallow dimethyl ammonium chloride, ditallowoyloxyethyl dimethyl ammonium methyl sulfate, dihydrogenated-tallowoyloxyethyl dimethyl ammonium chloride, dihydrogenated-tallowoyloxyethyl dimethyl ammonium chloride and mixtures thereof.

In one embodiment the FSA comprises from at least about 1%, alternatively at least about 2%, alternatively at least about 3%, alternatively at least about 4%, alternatively at least about 5%, alternatively about 6%, alternatively at least about 7%; but not greater than about 12%, alternatively not greater than 10%, alternatively not greater 9%, alternatively not greater than about 8%, alternatively not greater than about 7.5%, alternatively not greater than about 7%, alternatively not greater than about 6.5%, alternatively not greater than about 6%, alternatively not greater than about 5.5%, alternatively not greater than about 5% by weight of the fabric care composition.

5. Softness Robustness.

Softness Robustness Test Method: In one embodiment of the invention, the composition exhibits fabric softness robustness in a rinse bath solution under anionic carry-over conditions. A suitable softness robustness test method is described at U.S. Pat. Appl. Pub. No. US 2003/0060390, to Demeyere, published Mar. 27, 2003, at paragraphs 230-233.

6. Energy Input

Surprisingly small unilamellar vesicles are made using “ordinary energy” i.e., less than <0.1 watts/ml. Not to be bound by theory, but ordinary energy typically results in multilamellar vesicles in compositions comprising typically higher levels of mono-tail quats. Due to the presence of a high level of mono-tail quats, only ordinary energy is necessary to attain a unilamellar structures.

### B. CATIONIC STARCH

One aspect of the present invention provides for a fabric care composition comprising a cationic starch. Cationic starch surprisingly may provide inhibit floc (e.g., scum or precipitate) formation; fabric softening benefits; and/or thickening benefits. Compositions comprising cationic starch may also provide enhanced performance of the inventive compositions under anionic carry-over conditions.

The term “cationic starch” is used herein in the broadest sense. In one aspect of the invention, cationic starch refers to starch that has been chemically modified to provide the starch with a net positive charge in aqueous solution at pH 3. This chemical modification includes, but is not limited to, the addition of amino and/or ammonium group(s) into the starch molecules. Non-limiting examples of these ammonium groups may include substituents such as trimethylhydroxypropyl ammonium chloride, dimethylstearylhydroxypropyl ammonium chloride, or dimethyldodecylhydroxypropyl ammonium chloride. See Solarek, D. B., Cationic Starches in Modified Starches: Properties and Uses, Wurzburg, O. B., Ed., CRC Press, Inc., Boca Raton, Fla. 1986, pp 113-125.

In one embodiment, the fabric care compositions of the present invention generally comprise cationic starch at a level of from about 0.1% to about 7%, alternatively from about 0.1% to about 5%, alternatively from about 0.3% to about 3%, alternatively from about 0.5% to about 2%, alternatively from about 0.01% to about 5%, and alternatively from about 0.3% to about 2%, by weight of the composition. Cationic starch is described in U.S. Pat. Pub. 2004/0204337 A1, published Oct. 14, 2004, to Corona et al., at paragraphs 16-32. Suitable cationic starches for use in the present compositions are commercially-available from Cerestar under the trade name C*BOND® and from National Starch and Chemical Company under the trade name CATO® 2A. In another embodiment, the fabric care composition is free or essentially free of a cationic starch.

### C. SUDS SUPPRESSOR

One aspect of the invention provides suds suppression. Thus, in one embodiment of the invention, the fabric softening composition of the present invention comprises a suds suppressor. Non-limiting examples of a suds suppressor (or “suds suppressing systems”) is detailed in U.S. Pat. Pub. No. 2003/0060390 A1, to Demeyere et al., published Mar. 27, 2003, at paragraphs 65-77.

In one embodiment of the invention, the composition of the present invention comprises suds suppressor comprising an organopolysiloxane together with a silicone resin. In another embodiment, the composition comprises an organopolysiloxane without a silicone resin. Optionally, the organopolysiloxane is linear. The silicone resin may be optionally a silicate. In turn, the silicate may be optionally modified. A nonlimiting example of a silicate modification is end-capping the silicate with one or more trimethylsiloxy groups.

In a second embodiment, the suds suppressor is a silicone comprising emulsion that is dispersed in the fabric softener composition.

In a third embodiment, the composition comprising an amount of a suds suppressor such that when the composition is dosed in a rinse bath solution, a parts per million (ppm) of from 50 to 500, alternatively from 100 to 400 ppm, alternatively from 120 to 250 ppm, alternatively from 150 to 200 ppm of said suds suppressor is achieved in the rinse bath solution.

The silicone suds suppressor typically has a median particle size of at least about 6 microns, alternatively at least about 8 microns, alternatively at least about 10 microns, and alternatively at least about 15 microns; and typically a median particle size less than about 500 micron, alternatively less than about 100 micron.

One example suitable suds suppressor includes an emulsified dispersion of hydrophobic silica in silicone oil at about 20% activity in water from Wacker. Other manufacturers of silicone suds suppressors include General Electric, Dow Corning, and Shin Etsu.

Suds Reduction Test. One aspect of the invention provides for the reduction of suds in a rinse bath solution. A suitable “Suds Reduction Test” is detailed in U.S. Pat. Appl. Pub. No. US 2003/0060390, to Demeyere, published Mar. 27, 2003, at paragraph 229. In one embodiment, the composition of the present invention has a suds reduction over the reference or “suds reduction value” of about at least about 90%, alternatively at least about 95%, alternatively at least about 99%. For purposes of clarification, a suds reduction of about 99% means all the foam disappears from the optional presence of a white film or some scattered air bubbles that may partially cover the surface of the solution.

In one embodiment, the suds suppressor is at level from about 0.001% to about 10%, alternatively from about 0.01% to about 5%, alternatively from about 0.012% to about 1%, alternatively from about 0.05% to about 2% by weight of the fabric care composition.

### D. AQUEOUS CARRIER

The compositions of the present invention may comprise an aqueous carrier comprising water. When an aqueous carrier is included in the composition comprising a DEQA fabric softening active, it is preferred to adjust the pH such that the said composition has a pH that is 2 to about 5, alternatively from about 2 to about 4.5, and alternatively from about 2.5 to about 4.

### E. ADJUNCT FABRIC SOFTENING ACTIVES

The compositions of the present invention may comprise adjunct fabric softening actives. These active may include one or more of the following: silicones, including those described in U.S. Pat. Pub. No. 2002/0077265 A1, to Buzzacarini et al., published Jun. 20, 2002 at paragraphs 51-57; clays as described in U.S. Pat. Pub. No. 2004/0142841 A1, published Jul. 22, 2004, to de Buzzaccarini et al., from paragraphs 74-99; fats and/or fatty acids U.S. Prov. Appl. No. 60/621,204, filed Nov. 22, 2004 (P&G Case 9812) and non-provisional application thereof; polyhydroxy amide structures as described in U.S. Pat. No. 5,534,197 by Scheibel et al. and U.S. Pat. No. 5,512,699 by Connor et al.; Pentaerythritol compounds and derivatives thereof as disclosed in U.S. Pat. No. 6,294,516; cyclic polyols and/or reduced saccharides as disclosed in U.S. Pat. No. 6,410,501.

In one embodiment, the composition comprises sucrose ester-based fabric care materials. These materials compose of a sucrose derivatized by esterification and has the following formula:
M(OH)8-x(OC(O)R1)x

wherein M(OH)₈ represents the sucrose molecule having a cyclic backbone of M and M(OH)8-x represents the sucrose backbone having (8-x) un-derivatized hydroxyl groups;

x is an integer selected from 1 to 8, or from 2 to 8, or from 3 to 8, or from 4 to 8; and

R1 are independently selected from C₁-C₂₂ alkyl or C₁-C₃₀ alkoxy, linear or branched, cyclic or acyclic, saturated or unsaturated, substituted or unsubstituted.

In one embodiment, the R1 moieties comprise linear alkyl or alkoxy moieties having independently selected and varying chain length. For example, R1 may comprise a mixture of linear alkyl or alkoxy moieties wherein greater than about 20% of the linear chains are C₁₈, or greater than about 50% of the linear chains are C₁₈, or greater than about 80% of the linear chains are C₁₈.

In another embodiment, the composition comprises an olyhydroxy material or sugar derivative. Polyhydroxy amide structures as disclosed in U.S. Pat. No. 5,534,197 by Scheibel et al. and U.S. Pat. No. 5,512,699 by Connor et al.; Pentaerythritol compounds and derivatives as disclosed in U.S. Pat. No. 6,294,516; cyclic polyols and/or reduced saccharides as disclosed in U.S. Pat. No. 6,410,501.

In one embodiment, the composition of the present invention comprises from about 0.001% to about 10% of an adjunct fabric softening compound. In another embodiment, the compositions are free or essentially free of one the aforementioned adjunct fabric softening actives.

### F. THICKENER

The compositions of the present invention comprise a thickener. In one embodiment, the thickener is the polymerization product of:

(i) 5 to 80 weight percent of an alkyl ester of acrylic acid or an alkyl ester of methacrylic acid, wherein the alkyl group is linear or branched containing 1 to 22 carbons and optionally interrupted by oxygen.

(ii) 5 to 80 weight percent of a monomer selected from the group consisting of a vinyl-substituted heterocyclic compound containing at least one nitrogen, oxygen, or sulfur atom, (meth)acrylamide, a mono- or di-alkylamino alkyl(meth)acrylate, and a mono or di-alkylamino alkyl(meth)acrylamide, wherein the alkyl group has 1 to 4 carbon atoms;

(iii) 0.01 to 30 weight percent of an associative monomer selected from the group consisting of (a) urethane reaction products of a monoethylenically unsaturated isocyanate and non-ionic surfactants comprising C₁-C₄ alkoxy-terminated block copolymers of ethylene oxide, propylene oxide, or 1.2-butylene oxide; (b) an ethylenically unsaturated copolymerizable surfactant monomer obtained by condensing a nonionic surfactant with an ethylenically unsaturated carboxylic acid or the anhydride thereof; (c) a surfactant monomer selected from the group consisting of urea reaction product of a monoethylenically unsaturated monoisocyanate with a nonionic surfactant having amine functionality; (d) an allyl ether of the formula CH₂═CR′CH₂OAₘBₙAₚR wherein R′ is hydrogen or methyl, A is propyleneoxy or butyleneoxy, B is ethyleneoxy, n is zero or an integer, m and p are zero or an integer less than n, and R is a hydrophobic group of at least 8 carbon atoms; and (e) a nonionic urethane monomer which is the urethane reaction product of a monohydric nonionic surfactant with a monoethylenically unsaturated isocyanate; and

(iv) 0 to 1 weight percent of a cross-linking monomer having at least two ethylenically unsaturated moieties wherein the weight percent of monomers is based on 100 weight percent. Examples of cross-linking monomers used in the present invention include and are not limited to ethylene glycol diacrylate, divinylbenzene, pentaerythritol triacrylate glycerol triglycidyl ether, and ethylene glycol diglycidyl ether.

Further detail about thickeners or “polymer rheology modifiers” are described in U.S. Pat. No. 6,465,416 B2, at column 2, line 58 et seq.

The fabric softening compositions of the present invention comprise from about 0.01% to about 20%, alternatively by weight of the composition of a thickener.

In another aspect of the present invention, that composition of the present invention has a viscosity of less than about 1000 cPs., alternatively less than about 700 cPs, alternatively less than about 500 cPs, alternatively less than about 350 cPs; but at least about 10 cPs, alternatively at least about 30 cPs, and alternatively greater than about 80 cPs. One way to measure viscosity is to measure the composition at 25° C. with a Brookfield® viscometer using a No. 2 spindle at 60 rpm.

Yet another aspect of the invention provides a composition that exhibits excellent stability over time attributable, at least in part, to the thickeners described herein. Preferably the thickened fabric care composition exhibits extended stability over a wide range of temperatures, wherein the fabric care composition changes viscosity by less than 150% for at least 2 days at temperatures between 4 to 38 degrees Celsius.

### G. PARTICLE SIZE

One aspect of the invention provides for a FSA, in one embodiment the FSA is an ester quaternary compound suitable for softening fabric, to form particles in the fabric care composition. Without wishing to be bound by theory, compositions with smaller particle sizes provide a more uniform softening on fabrics and deeper penetration into the fabric for deposition as compared to those fabric care compositions with larger particle sizes. Additionally, and again without wishing to be bound by theory, when the FSA comprises an ester quaternary ammonium compound, an optimal ratio of monoester species to diester species may contribute, at least in part, to a smaller vesicle size formation. Moreover, an optimized ratio of monoester to diester may also lead to compositions (in addition to having a smaller particle size) are more resilient to LAS carry-over when anionic-based detergents are used and provide improved softness in the presence of LAS carry-over.

In one embodiment, the particles are distributed in the composition so that at least 50%, alternatively at least 60%, alternatively at least 70%, alternatively at least 80%, alternatively at least 85%, alternatively at least 90%, by the total number of the FSA particles comprise an average diameter of less than about 3 microns, but greater than 0.05 microns, as measured by the HORIBA™ Light Scattering Technique. In another embodiment, the particles are distributed in the composition so that at least 50%, alternatively at least 60%, alternatively at least 70%, alternatively at least 80%, alternatively at least 85%, alternatively at least 90%, by the total number of the FSA particles comprise an average diameter of less than about 1 micron, but greater than 0.05 microns, as measured by the HORIBA™ Light Scattering Technique.

The term “HORIBA™ Light Scattering Technique” means a technique where particle-size distribution as an average diameter is determined using a LA-910™ Laser Scattering Particle Size Distribution Analyzer equipped with a flow cell. Approximately 0.3 mLs of fabric softener composition is added to approximately 150 mLs of deionized water in the sampling chamber (so that the transmission intensity is between 80-95%, as specified by HORIBA). For best results, the sample is circulated and analyzed within 1 minute of introduction into the sample chamber. Thereafter, the particle size distribution is measured using Horiba LA-910 Measurement Program, Version 1.30, using the volume distribution base and a relative refractive index of 1.03. For purposes of clarification, one skilled in the art will readily appreciate that FSA formed particles may comprise other ingredients in relatively minor amounts such as, but not limited to, unreacted fatty acids from the manufacture of ester quaternary ammonium compounds or hydrophobic perfume ingredients that have migrated into the particle.

### H. ELECTROLYTE

One surprising observation of the present invention is the need for little, if any, addition of electrolyte to the compositions of the present invention. Electolytes may be organic or inorganic compounds and are typically used inter alia for aiding in the formation of dispersed lamellar phase on dilution and for preventing dilution through high viscosity phases. Suitable inorganic electrolytes for the present invention include but are not limited to salts comprising sodium, potassium, magnesium, calcium, aluminum, lithium, and combinations thereof. Electrolytes are further described in U.S. Pat. Pub. No. 2004/0204337 A1, published Oct. 14, 2004, to Corona et al. from paragraphs 80-84

In one embodiment, the compositions of the present invention comprises less than about 3%, alternatively less than about 2%, alternatively less than about 1%, alternatively less than about 0.5%, alternatively less than about 0.1%, alternatively less than about 0.01%, alternatively less than about 0.001% electrolyte by weight of the composition. In another embodiment, the composition comprise at least 0.001% electrolyte by weight of the composition.

### I. PERFUME

As used herein, perfume includes fragrant substance or mixture of substances including natural (i.e., obtained by extraction of flowers, herbs, leaves, roots, barks, wood, blossoms or plants), artificial (i.e., a mixture of different nature oils or oil constituents) and synthetic (i.e., synthetically produced) odoriferous substances. Such materials are often accompanied by auxiliary materials, such as fixatives, extenders, stabilizers and solvents. These auxiliaries are also included within the meaning of “perfume”, as used herein. Typically, perfumes are complex mixtures of a plurality of organic compounds.

Perfume ingredients may also be suitably added as releasable fragrances, for example, as pro-perfumes or pro-fragrances as described in U.S. Pat. No. 5,652,205 Hartman et al., issued Jul. 29, 1997.

Perfume microcapsules may include those described in the following references: US 2003-215417 A1; US 2003-216488 A1; US 2003-158344 A1; US 2003-165692 A1; US 2004-071742 A1; US 2004-071746 A1; US 2004-072719 A1; US 2004-072720 A1; EP 1393706 A1; US 2003-203829 A1; US 2003-195133 A1; US 2004-087477 A1; US 2004-0106536 A1; U.S. Pat. No. 6,645,479; U.S. Pat. No. 6,200,949; U.S. Pat. No. 4,882,220; U.S. Pat. No. 4,917,920; U.S. Pat. No. 4,514,461; U.S. RE 32713; U.S. Pat. No. 4,234,627. For purposes of the present invention, and unless indicated otherwise, the term “perfume nanocapsule” is within the scope of the term “perfume microcapsule.”

In one embodiment of the invention, the shell of the microcapsule comprises an aminoplast resin. A method for forming such shell capsules includes polycondensation. Aminoplast resins are the reaction products of one or more amines with one or more aldehydes, typically formaldehyde. Non-limiting examples of suitable amines include urea, thiourea, melamine and its derivates, benzoguanamine and acetoguanamine and combinations of amines. Suitable cross-linking agents (e.g., toluene diisocyanate, divinyl benzene, butane diol diacrylate etc.) may also be used and secondary wall polymers may also be used as appropriate, e.g. anhydrides and their derivatives, particularly polymers and co-polymers of maleic anhydride as disclosed in WO 02/074430. In another embodiment, the shell of the microcapsules comprises urea-formaldehyde; melamine-formaldehyde; or combinations thereof.

In one embodiment, the microcapsule is one that is friable in nature. “Friability” refers to the propensity of the microcapsules to rupture or break open when subjected to direct external pressures or shear forces. For purposes of the present invention, the microcapsules utilized are “friable” if, while attached to fabrics treated therewith, they can be ruptured by the forces encountered when the capsule-containing fabrics are manipulated by being worn or handled (thereby releasing the contents of the capsule).

In one embodiment, the shell capsules typically have a mean diameter in the range 1 micrometer to 100 micrometers, alternatively from 5 micrometers to 80 microns, alternatively from 10 micrometers to 75 micrometers, and alternatively between 15 micrometers to 50 micrometers. The particle size distribution can be narrow, broad or multimodal.

In another embodiment, microcapsules vary in size having a maximum diameter between about 5 microns and about 300 microns, alternatively between about 10 microns and about 200 microns. As the capsule particle size approaches 300 microns, e.g. 250 microns), a reduction in the number of capsules entrained in the fabric may be observed.

In another embodiment, the capsules utilized in the present invention generally have an average shell thickness ranging from about 0.1 micron to 50 microns, alternatively from about 1 micron to about 10 microns.

In yet another embodiment, the composition of the present invention comprises an odor control agent. Such agents include those described in U.S. Pat. No. 5,942,217 such as uncomplexed cyclodextrin. Other agents suitable odor control agents include those described in the following: U.S. Pat. No. 5,968,404, U.S. Pat. No. 5,955,093; U.S. Pat. No. 6,106,738; U.S. Pat. No. 5,942,217; and U.S. Pat. No. 6,033,679.

Perfume is included in the fabric softening composition at a level of at least 0.1%, preferably at least 0.3%, more preferably at least 0.5%, more preferably at least about 1%, and less than about 10%, preferably less than about 5% by weight of the fabric care composition.

### J. ADJUNCT MATERIALS

One aspect of the invention provides a composition that includes one or more of the following adjunct materials: perfumes, dispersing agents, stabilizers, pH control agents, metal ion control agents, colorants, brighteners, dyes, odor control agent, pro-perfumes, cyclodextrin, perfume, solvents, soil release polymers, preservatives, antimicrobial agents, chlorine scavengers, anti-shrinkage agents, fabric crisping agents, spotting agents, anti-oxidants, anti-corrosion agents, bodying agents, drape and form control agents, smoothness agents, static control agents, wrinkle control agents, sanitization agents, disinfecting agents, germ control agents, mold control agents, mildew control agents, antiviral agents, anti-microbials, drying agents, stain resistance agents, soil release agents, malodor control agents, fabric refreshing agents, chlorine bleach odor control agents, dye fixatives, dye transfer inhibitors, color maintenance agents, color restoration/rejuvenation agents, anti-fading agents, whiteness enhancers, anti-abrasion agents, wear resistance agents, fabric integrity agents, anti-wear agents, defoamers and anti-foaming agents, rinse aids, UV protection agents, sun fade inhibitors, insect repellents, anti-allergenic agents, enzymes, flame retardants, water proofing agents, fabric comfort agents, water conditioning agents, shrinkage resistance agents, stretch resistance agents, enzymes, and mixtures thereof. These ingredients are described in further detail in EP 1,297,101 and pending as U.S. Pat. Pub. No. 2005/0026793 A1 (P&G Case 8079M) and the references cited therein; and U.S. Pat. Pub. No. US 2003/0060390, to Demeyere, published Mar. 27, 2003, at paragraphs 123-222. Another aspect of the invention provides a composition that is free or essentially free of any one or more of the above-identified adjunct materials.

As used herein the term “essentially free” or “substantially free” means less than 1%, alternatively less than 0.01%, alternatively less than 0.001%, alternatively about 0% of subject ingredient(s) by weight of the composition.

In yet another embodiment, the composition is free or essentially free of a detersive laundry surfactant. In still yet another embodiment, the composition is used in a laundry rinse, i.e., not in the wash cycle. In yet still another embodiment, a kit is provided comprising a composition of the present invention and optionally instructions for use thereof. In yet still another embodiment, a method of softening fabric is provided wherein a composition of the present invention is dosed or caused be dosed during the rinse cycle of an automatic laundry washing machine.

### K. METHODS OF USE

One aspect of the invention provides for a method of treating a fabric in a manual rinse processes comprising the steps: (a) adding a composition of the present invention to a first rinse bath solution; (b) rinsing manually the fabric in the first rinse bath solution.

### L. EXAMPLES

### Examples I, II, and III

| | EXAMPLES | | |
|---|---|---|---|
| INGREDIENTS | I | II | III |
| Fabric Softening Active^{a} | 5.40% | 5.78% | 5.78% |
| Ethanol | 0.73% | 0.78% | 0.78% |
| Cationic Starch^{b} | 0.67% | 0.5% | 0.5% |
| Perfume | 0.65% | 0.6% | 0.6% |
| Rheology Modifier^{c} | 0.35% | 0.275% | 0.8% |
| Phase Stabilizing Polymer^{d} | — | — | — |
| Calcium Chloride | — | — | — |
| DTPA^{e} | 0.0023% | 0.0023% | 0.0021% |
| Preservative^{f} | 5 ppm | 5 ppm | 5 ppm |
| Antifoam^{g} | 0.015% | 0.015% | 0.015% |
| Dye | 30 ppm | 30 ppm | 40 ppm |
| Ammonium Chloride | — | — | — |
| Hydrochloric Acid | 0.0125% | 0.0125% | 0.0125% |
| Deionized Water | Balance | Balance | Balance |
| | Characteristics | | |
| pH^{h} | 3.46 | 2.92 | 3.72 |
| Viscosityⁱ | 95 cps | 88 cps | 173 cps |
| Particle sizes^{j} | 1.049 μm | 0.9124 μm | 1.049 μm |

^{a}N,N-di(tallowoyloxyethyl)-N,N-dimethylammonium chloride.
^{b}Cationic starch based on common maize starch or potato starch, containing 25% to 95% amylose and a degree of substitution of from 0.02 to 0.09. Available from Cerestar under the trade name C*BOND ® and National Starch under the trade name CATO ® A2.
^{c}Alcogum L-520
^{d}Copolymer of ethylene oxide and terephthalate having the formula described in U.S. Pat. No. 5,574,179 at col.15, lines 1-5, wherein each X is methyl, each n is 40, u is 4, each R¹ is essentially 1,4-phenylene moieties, each R² is essentially ethylene, 1,2-propylene moieties, or mixtures thereof.
^{e}Diethylenetriaminepentaacetic acid.
^{f}KATHON ® CG available from Rohm and Haas Co.
^{g}Silicone antifoam agent available from Dow Corning Corp. under the trade name DC2310.
^{h}pH of the fabric care compositions is measured using a Orion 710A+ pH meter.
ⁱViscosity of the fabric care compositions is measured using a Brookfield Viscometer, spindle #2, at 60 rpm. Based on spindle size and rpm, there is a +/−5 cps error.
^{j}Particle size distribution was determined using the HORIBA Light Scattering Technique as previously defined.

### Example IV

### Making the Fabric Care Composition Using a Water Dispersible Structurant (Lab Scale)

Begin agitating base product at medium speed, or about 400 rpm, using an overhead IKA Werk Mixer with a Rushton impeller. Add the thickener into the agitating base product. Mix at 400 rpm for 2 minutes. Other adjunct ingredients, including but not limited to any perfumes or dyes, may be added to the base product once the rheology modifier has mixed with base product for 2 minutes. Mix final product for at least 5 minutes.

### Example V

### Measuing Dispersability of Rheology Modifiers

Dispersability of rheology modifiers is measured using one of the following methods:

(a) 0.1 active weight % of the rheology modifier is added into 200 ml water using an overhead IKA Werk mixer with a Rushton impeller at low agitation, or about 200 rpm. Water may be acidified to pH 3 using hydrochloric acid to simulate typical fabric care compositions. Visual observations are made after 30 seconds, 1 minute and 2 minutes or at longer intervals as needed. Timing begins upon completion of rheology modifier addition. Preferred rheology modifiers disperse completely at or before 30 seconds or more preferably, immediately upon addition to water, showing no visible particles in the solution. Table I lists dispersability observations for various preferred rheology modifiers and non-preferred rheology modifiers of the present invention.

TABLE I
Dispersability Characteristics of Rheology Modifiers in Water

| | Time | | | | |
|---|---|---|---|---|---|
| Material tested | Interval | | Viscosity | | Dispersability Observations |
| Alcogum L520 | 30 | seconds | 5 | cps | Disperses immediately. No |
| (in acidified | | | | | visible particles. Mixture is |
| water) | | | | | clear. |
| | 1 | min | 5 | cps | No visible particles. Mixture |
| | | | | | is clear. |
| | 2 | min | 5 | cps | No visible particles. Mixture |
| | | | | | is clear. |
| Alcogum L520 | 30 | seconds | 2.5 | cps | Disperses immediately. No |
| | | | | | visible particles. Turbid |
| | | | | | solution. |
| | 1 | min | 2.5 | cps | No visible particles. Turbid |
| | | | | | solution. |
| | 2 | min | 0 | cps | No visible particles. Turbid |
| | | | | | solution. |
| Flosoft 200 | 30 | seconds | 295 | cps | White particulates observed |
| | | | | | throughout mixture. |
| | 1 | min | 313 | cps | White particulates observed |
| | | | | | throughout mixture. |
| | 2 | min | 313 | cps | Few white particulates |
| | | | | | observed throughout mixture. |
| | 5 | min | 313 | cps | No visible particulates. |
| Synthalen CR | 30 | seconds | 5 | cps | Powder clumps visible. |
| | | | | | Translucent globules visible |
| | | | | | and appear to be gelatinous |
| | | | | | outside with trapped powder |
| | | | | | inside. |
| | 1 | min | 10 | cps | Translucent globules visible |
| | | | | | and appear to be gelatinous |
| | | | | | outside with trapped powder |
| | | | | | inside. |
| | 2 | min | 20 | cps | Translucent globules visible |
| | | | | | and appear to be gelatinous |
| | | | | | outside with trapped powder |
| | | | | | inside. |
| | 5 | min | 20 | cps | Translucent globules visible |
| | | | | | and appear to be gelatinous |
| | | | | | outside with trapped powder |
| | | | | | inside. |

(b) 0.1 active weight % or appropriate level of the rheology modifier is added into 200 ml of a fabric care composition containing a biodegradable ester quaternary compound using an overhead IKA Werk mixer with a Rushton impeller at low agitation, or about 200 rpm. Perfume is added after the addition of the rheology modifier. Visual observations and viscosity measurements are made after 30 seconds, 1 min and 2 minutes or at longer time intervals as needed. Timing begins upon completion of perfume addition. Preferred rheology modifiers disperse completely at or before 30 seconds upon addition to the fabric care composition, showing no visible particles in the solution. Additionally, preferred rheology modifiers reach the final viscosity range at or before 30 seconds upon addition to the fabric care composition. Table II lists the dispersability observations and viscosity measurements for various preferred rheology modifiers and non-preferred rheology modifiers.

### Table II

TABLE II
Dispersability Characteristics and Viscosities of Rheology
Modifiers in a Fabric Care Composition

| Material Tested | Time Interval | | Viscosity | Dispersability Observations |
|---|---|---|---|---|
| 0.1% Alcogum | 30 | seconds | 80 cps | No visible particles. |
| L520 | 1 | min | 85 cps | No visible particles. |
| | 2 | min | 85 cps | No visible particles. |
| 0.1% Flosoft | 30 | seconds | 95 cps | White particles visible. |
| 200 | 1 | min | 118 cps | White particles visible. |
| | 2 | min | 150 cps | White particles visible. |
| 0.03% Flosoft | 30 | seconds | 60 cps | White particles visible. |
| 200 | 1 | min | 65 cps | White particles visible. |
| | 2 | min | 75 cps | White particles visible. |
| | 6 | min | 85 cps | White particles visible. |
| 0.1% Synthalen | 30 | seconds | 50 cps | Large white agglomerates |
| CR | | | | visible. |
| | 1 | min | 50 cps | Large white agglomerates |
| | | | | visible. |
| | 2 | min | 55 cps | Large white agglomerates |
| | | | | visible. |
| | 6 | min | 70 cps | Large white agglomerates |
| | | | | visible. |

(c) 0.1 active weight % or appropriate level of the rheology modifier is added into 400 ml water in a 600 ml beaker using an overhead IKA Werk mixer with a pitched blade turbine at medium agitiation, or about 500 rpm. Water may be acidified to pH 3 using hydrochloric acid to simulate typical fabric care compositions. A ring stand and clamp is used to hold a Mettler-Toledo 8200 Turbidity Probe, which is submersed in the solution. For each sample, a base-line turbidity measurement of the water was recorded and used as the normalization factor. Subsequent turbidity measurements, reported in National Transmittance Units (NTU), of the solution are recorded at 5 second intervals for approximately 1 minute and at 10 second intervals for as long as needed, no longer than approximately 7 minutes, using the Mettler-Toledo 8300 Turbidity Transmitter. Preferred rheology modifiers disperse in solutions that reach steady-state turbidity at or before 40 seconds. Table III lists the times to reach steady-state turbidity of various preferred rheology modifiers and non-preferred rheology modifiers.

TABLE III
Required Time to Reach Steady-State Turbidity
of Rheology Modifiers in Water

| | Time to Reach |
|---|---|
| Material Tested | Steady-State Turbidity |
| 0.1% Alcogum L520 (in acidified water) | ≦10 sec |
| 0.1% Alcogum L520 | ≦40 sec |
| 0.1% Flosoft 200 | ≦90 sec |
| 0.03% Flosoft 200 | ≦60 sec |
| 0.1% Synthalen CR | >430 sec |

### Example VI

### Compositions

| | EXAMPLES | | | | | |
|---|---|---|---|---|---|---|
| INGREDIENTS | A | B | C | D | E | F |
| Fabric Softening Active^{a} | 6.5% | 4.875% | 6.5% | 7.25% | 7.5% | 5% |
| Fabric Softening Active^{b} | 0% | 1.625% | 0% | 0% | 0% | 0% |
| Isopropanol | 1.22% | 1.15% | 1.22% | 1.35% | 1.4% | 0.91% |
| Suds Suppressor^{c} | 0.1% | 0.1% | 0.1% | 0.1% | 0.13% | 0.1% |
| Cationic Starch^{d} | 0% | 0% | 0.7% | 0% | 0% | 1.0% |
| Perfume | 0.8-1.5% | 0% | 0.8-1.5% | 0.8-1.5% | 0.8-1.5% | 0.8-1.5% |
| Rheology Modifier^{e} | 0% | 0% | 0% | 0% | 0% | 0.2% |
| Calcium Chloride | 0.1-0.15% | 0.1-0.15% | 0.1-0.15% | 0.1-0.15% | 0.1-0.15% | 0.1% |
| Preservative^{f} | 0.025% | 0.025% | 0.025% | 0.025% | 0.0125% | 0.025% |
| Dye | 0.003%-0.03% | 0.003%-0.03% | 0.003%-0.03% | 0.003%-0.03% | 0.003%-0.03% | 0.003%-0.03% |
| Hydrochloric Acid | 0.025% | 0.023% | 0.025% | 0.025% | 0.021% | 0.020% |
| Deionized Water | Balance | Balance | Balance | Balance | Balance | Balance |

^{a}Reaction product of Fatty acid with Methyldiethanolamine in a molar ratio 1.5:1, quaternized with Methylchloride, resulting in a 1:1 molar mixture of N,N-bis(stearoyl-oxy-ethyl) N,N-dimethyl ammonium chloride and N-(stearoyl-oxy-ethyl) N,-hydroxyethyl N,N dimethyl ammonium chloride.
^{b}N,N-di(tallowoyloxyethyl)-N,N-dimethylammonium chloride.
^{c}SE39 from Wacker
^{d}Cationic starch based on common maize starch or potato starch, containing 25% to 95% amylose and a degree of substitution of from 0.02 to 0.09. Available from Cerestar under the trade name C*BOND ® and National Starch under the trade name CATO ® A2.
^{e}Alcogum L-520
^{f}gluteraldehyde.

| | EXAMPLES | | | | | |
|---|---|---|---|---|---|---|
| INGREDIENTS | G | H | I | J | K | L |
| Fabric Softening | 5% | 5% | 4% | 4% | 4% | 4% |
| Active^{a} | | | | | | |
| Isopropanol | 0.91% | 0.91% | 0.73% | 0.73% | 0.73% | 0.73% |
| Suds Suppressor^{c} | 0.075% | 0.075% | 0.075% | 0.075% | 0.075% | 0.075% |
| Cationic Starch^{d} | 0% | 0% | 0% | 0.45% | 0.2% | 0.3% |
| Perfume | 0.2-1% | 0.2-1% | 0.2-1% | 0.2-1% | 0.2-1% | 0.2-1% |
| Rheology Modifier^{g} | 0.28% | 0.3% | 0.36% | 0% | 0% | 0.36% |
| Calcium Chloride | 0% | 0% | 0% | 0.01% | 0.05% | 0.02% |
| Preservative^{f} | 0.0125% | 0.0125% | 0.0125% | 0.0125% | 0.0125% | 0.0125% |
| Dye | 0.003%-0.03% | 0.003%-0.03% | 0.003%-0.03% | 0.003%-0.03% | 0.003%-0.03% | 0.003%-0.03% |
| Hydrochloric Acid | 0.02% | 0.02% | 0.02% | 0.02% | 0.02% | 0.02% |
| Deionized Water | Balance | Balance | Balance | Balance | Balance | Balance |

^{g}Rheovis CSP

| | EXAMPLES | | | | | |
|---|---|---|---|---|---|---|
| INGREDIENTS | M | N | O | P | Q | R |
| Fabric Softening | 0% | 5.5% | 0% | 0% | 0% | 0% |
| Active^{a} | | | | | | |
| Fabric Softening | 5.5% | 0% | 5.5% | 6% | 5% | 4% |
| Activeⁱ | | | | | | |
| Isopropanol | 1% | 1% | 1% | 1.1% | 0.91% | 0.73% |
| Suds Suppressor^{c} | 0.07% | 0.1% | 0.06-0.13% | 0.9% | 0.8% | 0.11% |
| Cationic Starch^{d} | 0.6% | 0.5% | 0-0.5% | 0.5% | 0.3% | 0.2% |
| Perfume | 0.8-1.5% | 0.8-1.5% | 0% | 0.8-1.5% | 0.8-1.5% | 0.8-1.5% |
| Rheology Modifier^{g} | 0% | 0% | 0.39% | 0% | 0.45% | 0.45% |
| Calcium Chloride | 0.01-0.02% | 0.01-0.05% | 0.01-0.05% | 0.01-0.05% | 0.01-0.05% | 0.01-0.05% |
| Preservative^{f} | 0.0125% | 0.0125% | 0.0125% | 0.0125% | 0.0125% | 0.0125% |
| Dye | 0.003%-0.03% | 0.003%-0.03% | 0.003%-0.03% | 0.003%-0.03% | 0.003%-0.03% | 0.003%-0.03% |
| Hydrochloric Acid | 0.025% | 0.025% | 0.025% | 0.025% | 0.025% | 0.025% |
| Deionized Water | Balance | Balance | Balance | Balance | Balance | Balance |

ⁱReaction product of Fatty acid with Methyldiethanolamine and quaternized with Methylchloride, resulting in a 2.44:1 molar mixture of N,N-bis(stearoyl-oxy-ethyl) N,N-dimethyl ammonium chloride and N-(stearoyl-oxy-ethyl) N,-hydroxyethyl N,N dimethyl ammonium chloride.

### Example VII

### Particle Size Distribution for Fabric Care Compositions

Tables 4 and 5 provide the particle sizes for currently marketed products (with fabric softener actives <8%) and compositions of the present invention as determined by the HORIBA™ Light Scattering Technique (as previously defined).

TABLE 4
Particle sizes for currently marketed products.

| | | % Particles | % Particles | % Particles |
|---|---|---|---|---|
| | Bottle | with Size > | with Size > | with Size > |
| Composition | No. | about 3μ | about 1μ | about 0.2μ |
| Suavitel ® Fresca | 1 | 0.97 | 9.26 | 89.43 |
| Primavera | | | | |
| | 2 | 0.92 | 15.26 | 88.44 |
| | 3 | 0.42 | 25.87 | 93.94 |
| Suavitel ® Sin | 1 | 22.29 | 35.96 | 90.59 |
| Enjuague | | | | |
| | 2 | 21.47 | 34.44 | 89.27 |
| | 3 | 25.76 | 28.98 | 92.39 |
| | | 25.76 | 28.98 | 92.39 |
| Downy ® Aroma | 1 | 26.58 | 35.16 | 91.32 |
| Floral | | | | |
| | 2 | 26.58 | 35.16 | 01.32 |

TABLE 5
Particle sizes for compositions of the present invention.

| | % Particles | % Particles | % Particles |
|---|---|---|---|
| | with Size > | with Size > | with Size > |
| Composition | about 3μ | about 1μ | about 0.2μ |
| Example I | 0.21 | 0.21 | 77.13 |
| Example II | 0 | 0.60 | 8.47 |
| Example III | 1.35 | 1.48 | 72.23 |
| Example XIV | 3.88 | 1.005 | 79.16 |

### Example VIII

### LAS Tolerance of Fabric Care Compositions

Tables 6 and 7 provide LAS tolerance for currently marketed products (with fabric softener active <8%) and compositions of the present invention as determined by the Anionic Carryover Tolerance Test (as previously defined).

TABLE 6
LAS tolerance of currently marketed products

| | LAS Tolerance |
|---|---|
| Product | g LAS/0.74 g Composition (STD) |
| Suavitel ® Fresca Primavera | 2.49 g (0.09) |
| Suavitel ® Sin Enjuague | 2.67 g (0.12) |
| Downy ® | 2.87 (0.05) |

TABLE 7
LAS tolerance of compositions of the present invention

| | LAS Tolerance |
|---|---|
| Composition | g LAS/0.74 g Composition (STD) |
| Example A | 4.51 (0.09) |
| Example B | 4.62 (0.07) |
| Example C | 4.86 (0.09) |
| Example G | 4.78 (0.03) |
| Example I | 4.57 (0.09) |

### Example IX

### LAS Tolerance of a Large Particle Sized Composition

Table 8 is a composition comprising large sized FSA particles. Tables 9 and 10 demonstrate the deleterious effect of a fabric care composition (Example S) having a large particles relative to LAS tolerance.

TABLE 8
Composition of Example S

| | EXAMPLE |
|---|---|
| INGREDIENTS | S |
| Fabric Softening Active^{a} | 2.75% |
| Fabric Softening Active^{b} | 2.75% |
| Isopropanol | 1.0% |
| Suds Suppressor^{c} | 0.1% |
| Cationic Starch^{d} | 0.5% |
| Perfume | 0.8-1.5% |
| Rheology Modifier^{e} | 0% |
| Calcium Chloride | 0.01-0.05% |
| Preservative^{f} | 0.0125% |
| Dye | 0.003%-0.03% |
| Hydrochloric Acid | 0.025% |
| Deionized Water | Balance |

TABLE 9
Particle size distribution of Example S.

| | % Particles with | % Particles with | % Particles with |
|---|---|---|---|
| Composition | Size > about 3μ | Size > about 1μ | Size > about 0.2μ |
| Example S | 29.55 | 61.45 | 94.53 |

TABLE 10
LAS Tolerance of Example S.

| | LAS Tolerance |
|---|---|
| Composition | g LAS/0.74 g Composition (STD) |
| Example S | 2.25 (0.09) |

### Example X

### NaLAS Tolerance Levels as Measured by the Suds Cylinder Method

The suds reduction performance of currently marketed products and the compositions of the present invention under anionic surfactant carrier over conditions are compared. The Suds Cylinder Method is herein described: a suds cylinder test machine consisting of a rotating frame with space for at least 6 cylinders. The cylinders are made of a hard, clear material, such as PLEXI-glass™ an internal diameter of 9 cm and a height of 30 cm. The cylinder also has lid made of the same material as the cylinder to allow one to observe inside the cylinder.

Each sample of the fabric care composition is tested in a cylinder, in duplicate, at 3 levels of NaLAS, under the following conditions:

| | | |
|---|---|---|
| Rotation speed | 30 | rpm |
| Rotation time | 5 | min |
| Rinse solution size (deionized | 300.00 | g |
| water) | | |
| sample of the fabric care | 3.00 | g |
| composition | | |

| | |
|---|---|
| NaLAS^{j} levels | 0.12%, 0.14% and 0.16% |

^{j}Dodecylbenzenesulfonic acid, Aldrich

The cylinders are closed with lids and placed on the suds cylinder test machine. The rotation speed is adjusted to 30 rotations per minute (rpm). After 5 minutes, the machine is stopped and the time (in seconds) is measured for suds to collapse completely (“collapse time”). Suds collapse is measured by the unaided eye viewing through the cylinder/cylinder lid.

The “tolerated NaLAS level” is calculated by interpolating the NaLAS level for which the collapse time is 10 seconds. This method is suitable for fabric softeners containing a high level of silicone suds suppressor (0.1-0.15% active by weight of fabric care composition) and FSA level between 7-9% by weight of the fabric care composition. The FSA dosage and/or NaLAS levels may need to be recalculated when silicone suds suppressor level and/or the FSA level are outside these ranges.

TABLE 11
Collapse Time of Various Samples.

| | | % Na LAS | | |
|---|---|---|---|---|
| Formulation | Run # | 0.012% | 0.014% | 0.016% |
| A | 1 | 8 s* | 8 | 9 |
| | 2 | 6 s* | 7 | 8 |
| C | 1 | 5 s* | 6 | 7 |
| | 2 | 5 s* | 6 | 7 |
| Sauvitel ® | 1 | >120 s** | >120 s** | >120 s*** |
| Single Rinse | | | | |
| (Colgate) | | | | |
| | 2 | >120 s** | >120 s** | >120 s*** |
| O | 1 | 8 | 10 | 14 |
| | 2 | 9 | 11 | 14 |

*thin residual film
**thin foam layer
***0.5 cm foam layer

### Example 11

### Determining Cationic Starch Content in Fabric Enhancers

Principle: The content of cationic starch in liquid fabric enhancer (LFE) formulas is measured through the use of two amylolytic enzymes that selectively hydrolyze large starch polymeric chains to single glucose molecules that are directly measured via a colorimetric method in solution after the enzymatic digestion goes to completion. The level of glucose is then be used to calculate the amount of cationic starch in the FLE sample.

Equipment: UV/Vis spectrophotometer is set at 340 nm wavelength, pH meter, microcentrifuge, Incubator/Shaker set at 50° C. constant temperature, and analytical balance.

Reagents and Solution Preparation

Reagents. Glucose HK assay reagent (Hexakinase-glucose 6-phosphate dehydrogenase, Sigma, Cat #: G-2020), MOPS (3-morpholinopropanesulfonic acid, Sigma, Cat #: M-3183), Glucose (Fluka, Cat #: 49139), Acetic Acid (J.T. Baker, Cat #: 9515-03, or equivalent), Thermostable alpha amylase (Megazyme, Cat #: E-BLAAM), Amyloglucosidase (Megazyme, Cat #: E-AMGDF), 50% Sodium Hydroxide (EM Science, Cat#: SX0597-3, or equivalent), Calcium Chloride (Sigma, Cat # C-5080, or equivalent), blank LFE matrix free of starch.

Solution Preparation

Acetate Buffer (pH 4.5). Add 118 mL of glacial acetic acid to −800 mL DI water. Adjust pH of solution to 4.5 with 50% sodium hydroxide and dilute to 1 L with DI water.

MOPS Buffer (pH 7.0). Make 90 mmol MOPS in DI water. Stir solution until dissolution is complete, then adjust pH to 7.0 with concentrated hydrochloric acid. With continued stirring, add 0.074% w/v calcium chloride.

Glucose Stock. Make a 10,000 ppm Glucose stock in DI water with 800 uL of MOPS buffer and 200 uL of thermostable alpha amylase per 100 mL solution.

HK Glucose Reagent. Dilute contents of 0.5 mL reagent vial with 20 mL of DI water and mix gently by inversion several times.

Blank solution. Add 7.5 g of blank matrix free of starch to a 500 mL volumetric flask and dilute to volume with DI water. Shake to mix.

Analysis

Glucose Calibration Curve

Add X uL of the glucose Stock solution to a 100 mL. volumetric flask as shown in table. Dilute with approximately 50 mL of blank solution and repeat the same reagent additions steps for all calibrators and LFE sample solutions. The table below summarizes all necessary spikes for calibrator solutions.

| | | | | | Total |
|---|---|---|---|---|---|
| | | | | Thermostable | Volume |
| | Level | X uL of | MOPS | alpha | of |
| Calibrator | (ppm | Glucose | Buffer | amylase | Calibrator |
| # | Glucose) | stock | (mL) | (mL) | (mL) |
| 1 | 0.00 | 0 | 2.0 | 1.0 | 100 |
| 2 | 29.75 | 625 | 2.0 | 1.0 | 100 |
| 3 | 59.5 | 1250 | 2.0 | 1.0 | 100 |
| 4 | 119.0 | 2500 | 2.0 | 1.0 | 100 |

Weigh 1.5+0.0300 g of LFE sample into a 100 mL volumetric flask. Dilute with approx. 45 mL DI water. To each add 2 mL of MOPS buffer (sec. 5.2.2) to the flask and swirl to mix. Add 1 mL of thermal stable amylase to the flask and dilute to volume with DI water. Stir samples for 30 minutes. Remove a 1 mL aliquot from each sample and from each calibrator solution and place in separately labeled 2 mL microcentrifuge tubes that contain 1000 uL of acetate buffer. Add 100 uL amyloglucosidase to each tube and place in the incubator/shaker at 50 C/1400 rpm for 30 minutes. Remove from incubator and centrifuge for 4 minutes at 13,200 rpm. After centrifugation use transfer pipettes and remove ˜1.5 mL of supernatant from each tube and place in spectrophotometer sample cups (Note: Samples at this point should be run within 30 minutes after centrifugation). Place reagent, samples and calibrators in instrument and follow the instrument manual to analyze the samples and calibrate the instrument each run. Remove 500 uL of supernatant from each tube and place in separate vials. Add 1000 uL of MOPS buffer solution and mix solution. Allow 2 minutes for equilibration and then add 1500 uL of HK Glucose reagent and swirl to mix. Start timer. At 3 minutes read absorbance and determine concentration from calibration.
Calculations:
Concentration of Cationic Starch on LFE Sample (in % w/w)
Calculation of % Glucose and % Starch—required for final calculation of % Cationic

$$\% Glucose ( dextrose equivalents ) = \frac{( ppm Glucose ) \times DF}{Sample wgt . ( g )}$$

$$\begin{matrix}where DF = dilution factor \\ = 2.1 mL / 1 mL \times 100 mL \times ( 1 g \times 100 ) / 1 \text{,} 000 \text{,} 000 ug \\ = 0.021\end{matrix}$$

$$\begin{matrix}\% Starch = \% Glucose \times ( 162 g \text{/} mol / 180 g \text{/} mol ) \\ = \% Glucose \times 0.9\end{matrix}$$

Percent Cationic Starch in Downy—calculated as shown below using % Starch (8.2) and the Cationic Raw Material C/S Ratio (8.1).
% Cationic Starch=% Starch×Cationic Starch Raw Material C/S Ratio

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed:

1. A dilute liquid fabric care composition comprising:
(a) a fabric softener active;
(i) wherein the fabric softener active comprising from about 1% to about 12% by weight of the composition;
(ii) wherein the fabric softener active comprises an ester quaternary ammonium compound suitable for softening fabric;
(iii) wherein the ester quaternary ammonium compound forms particles in said composition;
(iv) wherein the particles are distributed so at least about 50% of the total number of the ester quaternary ammonium particles comprise an average diameter of less than 3 microns, but greater than 0.05 microns, as measured by the HORIBA Light Scattering Technique;
(b) a thickener comprising a polymerization product of:
(i) about 5 to about 80 weight percent of the thickener of an alkyl ester of acrylic acid or an alkyl ester of methacrylic acid, wherein the alkyl group is linear or branched containing 1 to 22 carbons and optionally interrupted by oxygen;
(ii) about 5 to about 80 weight percent of the thickener of a monomer chosen from: a vinyl-substituted heterocyclic compound containing at least one nitrogen, oxygen, or sulfur atom; (meth)acrylamide; a mono- or di-alkylamino alkyl(meth)acrylate; or a mono or di-alkylamino alkyl(meth)acrylamide, wherein the alkyl group preferably has 1 to 4 carbon atoms;
(iii) about 0.01 to about 30 weight percent of the thickener of an associative monomer chosen from at least one of the following:
(1) an urethane reaction product of a monoethylenically unsaturated isocyanate and a non-ionic surfactant comprising C₁-C₄ alkoxy-terminated, a block copolymer of ethyelene oxide; propylene oxide, or 1,2-butyleneoxide oxide;
(2) an ethylenically unsaturated copolymerizable surfactant monomer obtained by condensing a nonionic surfactant with an ethylenically unsaturated carboxylic acid or the anhydride thereof;
(3) a surfactant monomer chosen from a urea reaction product of a monoethylenically unsaturated monoisocyanate with a nonionic surfactant having amine functionality;
(4) an allyl ether of the formula CH₂═CR′CH₂OAₘBₙAₚR wherein R′ is hydrogen or methyl, A is propyleneoxy or butyleneoxy, B is ethyleneoxy, n is zero or an integer, m and p are zero or an integer less than n, and R is a hydrophobic group of at least 8 carbon atoms; and
(5) a nonionic urethane monomer which is an urethane reaction product of a monohydric nonionic surfactant with a monoethylenically unsaturated isocyanate;
(iv) about 0 to about 1 weight percent of the thickener of a cross-linking monomer having at least two ethylenically unsaturated moieties;
(c) water; and
(d) a viscosity of from about 10 cPs to about 1000 cPs.

2. The composition of claim 1, wherein the associative monomer is chosen from a urethane reaction product of a monoethylenically unsaturated isocyanate and a non-ionic surfactant comprising C₁-C₄ alkoxy-terminated, a block copolymer of ethyelene oxide, propylene oxide, or 1,2-butyleneoxide oxide.

3. The composition of claim 1, wherein the associative monomer comprises an ethylenically unsaturated copolymerizable surfactant monomer obtained by condensing a nonionic surfactant with an ethylenically unsaturated carboxylic acid or the anhydride thereof.

4. The composition of claim 1, wherein the associative monomer comprises a surfactant monomer chosen from a urea reaction product of a monoethylenically unsaturated monoisocyanate with a nonionic surfactant having amine functionality.

5. The composition of claim 1, wherein the associative monomer comprises an allyl ether of the formula CH₂═CR′CH₂OAₘBₙAₚR wherein R′ is hydrogen or methyl, A is propyleneoxy or butyleneoxy, B is ethyleneoxy, n is zero or an integer, m and p are zero or an integer less than n, and R is a hydrophobic group of at least 8 carbon atoms.

6. The composition of claim 1, wherein the associative monomer comprises a nonionic urethane monomer which is an urethane reaction product of a monohydric nonionic surfactant with a monoethylenically unsaturated isocyanate.

7. The composition of claim 1, wherein the particles are distributed so at least about 90% of the total number of the ester quaternary ammonium particles comprise an average diameter of less than 3 microns.

8. A fabric care composition comprising:
(a) a fabric softener active:
(i) wherein the fabric softener active comprises from about 1% to about 12% by weight of the composition;
(ii) wherein the fabric softener active comprises an ester quaternary ammonium compound suitable for softening fabric;
(iii) wherein the ester quaternary ammonium compound comprises a monoester species and a diester species;
(1) wherein the monoester species comprises from about 10% to about 50% by weight of the ester quaternary ammonium compound;
(2) wherein the diester species comprises from about 15% to about 80% by weight of the ester quaternary ammonium compound;
(3) wherein the mole ratio of the monoester species to diester species comprises from about 0.5:1 to about 1.3:1, respectively;
(vi) wherein the ester quaternary ammonium compound forms particles in the composition; wherein the particles are distributed so less than about 20% of the total number of ester quaternary ammonium compound particles have an average diameter greater than about 3 microns, as measured by the HORIBA Light Scattering Technique;
(b) from about 0.001% to about 10% by weight of the composition of a silicone comprising suds suppressor.

9. The composition of claim 8, wherein the diester species comprises at least about 65% of the total fabric softener active weight.

10. The composition of claim 9, wherein the diester species comprises at least about 70% of the total fabric softener active weight.

11. The use of the composition of claim 10 for the treatment of fabric, wherein the treatment comprises the steps: (a) adding the fabric conditioning composition to a first rinse bath solution; (b) rinsing manually the fabric in the first rinse bath solution.
